(19) United States
(12) Patent Application Publication
(10) Pub. No.: US 2004/0070823 A1
(43) Pub. Date: Apr. 15, 2004

(54) Head-mount recording of three-dimensional stereo video images

(76) Inventor: Richard J. Radna, Bronx, NY (US)

Correspondence Address: PATTON BOGGS LLP, 2550 M Street, NW, Washington, DC, 20037-1350, US

(21) Appl. No.: 10/268,071

(22) Filed: Oct. 10, 2002

(51) Int. Cl. G02B 23/00

(52) U.S. Cl. 359/407

(57) ABSTRACT

A head-mounted assembly provides simultaneous recording of 3D stereo video of surgical procedures. In addition, the head-mounted assembly provides a 3D stereo surgical video system that may be co-axial to a surgeon's bi-nocular optical view trajectory. The head-mounted assembly includes a head-mountable structure, a first telescope and a second telescope, and a first video camera and a second video camera. The head-mountable structure is mounted on the head of a user. The first telescope, the first video camera, the second telescope, and the second video camera are secured to the head-mountable structure. The first video camera is positioned in relation to a first line of sight, as viewed, through the first telescope, by a first eye of the user. On the other hand, the second video camera is positioned in relation to a second line of sight, as viewed, through the second telescope, by a second eye of the user.

### FIELD OF THE INVENTION

The present invention relates in general to head-mountable assemblies. In particular, the present invention relates to head-mount recording of three-dimensional stereo video images.

### BACKGROUND OF THE INVENTION

It is known to use magnifying optics such as a microscope or a telescope (also known as surgical telescopes, or surgical loupes) by a surgeon in performing a surgical procedure. The surgeon uses the microscope and/or the telescope, during the surgical procedure, to view a particular area being operated on. The microscope also allows the surgeon to video record, in two-dimensions (2D) or three-dimensions (3D), the surgical procedure, for example, for archival and educational purposes. The microscope, however, is relatively bulky, not portable, and relatively burdensome to use, for example, in procedures where surgeon mobility of view is optimal, such as in complex anatomical dissections.

The head-mounted surgical telescopes, unlike the microscope, is mounted on a head-mounted structure, which is mounted on the head of the surgeon, while the surgeon is performing the surgical procedure. Presently, surgical head-mounted bi-nocular telescopes are in general micro-surgical use, and provide excellent visualization with the use of high-power xenon headlights. The head-mounted structure is attached to only a single mono-video camera to allow the surgeon to video record the surgical procedure in 2 dimensions. Such a configuration allows the surgeon to see a three-dimensional image of the surgical site, while the mono-video camera merely captures a two dimensional (2D) image of such a site.

### BRIEF DESCRIPTION OF THE DRAWINGS

In the drawings, like reference numerals represent similar parts of the illustrated embodiments of the present invention throughout the several views and wherein:

FIG. 1 is a front view of an embodiment of a head-mounted assembly;

FIG. 1a is a pivot mechanism of an attachment structure of the embodiment of FIG. 1;

FIG. 2 is top view of the embodiment of FIG. 1;

FIG. 3 is a side view of the embodiment of FIG. 1;

FIG. 3a is a connecting structure between a forward and rearward portion of the embodiment of FIG. 1;

FIG. 4 is a side view taken along line IV-IV of FIG. 2;

FIG. 5a is a protective cover in accordance with the embodiment of FIG. 1;

FIG. 5b is a cross-sectional top view of a portion of a viewing assembly of the embodiment of FIG. 1;

FIG. 6 is a perspective view of a viewing assembly of the embodiment of FIG. 1 with the protective cover of FIG. 5A seated thereon; and

FIG. 7 is a block diagram of an embodiment of a head-mounted assembly coupled to a display device and/or a recording device to display and/or record, respectively, a three dimensional stereo video image corresponding to a first video signal and a second video signal.

### DETAILED DESCRIPTION

Presently, head-mount video recording of a surgical procedure is limited to only two-dimensional images, and not the more realistic three-dimensional images, for example, as viewed by a surgeon. In addition, the line of sight of the surgeon is different than the line of sight of the known mono video camera mounted on the surgeon's head. As a result, the surgeon's recording of the surgical procedure does not reflect the surgeon's actual line of sight during the surgery, but merely the line of sight of the video camera mounted on the surgeon's head. In small microsurgical incisions, the known video camera optical trajectory, which does not reflect the surgeon's optical trajectory, will therefore miss much of the deep surgical field view, as the video camera view will be blocked by more superficial anatomy, such as the patient's skin.

One embodiment of the present invention, for example, remedies a major deficit of known head-mounted bi-nocular surgical telescopes, e.g., the lack of capability of simultaneous recording of 3D stereo video of surgical procedures. The embodiment may include two stereo video cameras mounted on the surgeon's two optical telescopes, in order to minimize the non-coaxial optical/video trajectory limitation of video view. The stereo video cameras may be mounted, for example, as low as possible on top of the surgeon's optical telescopes. In addition, the embodiment may provide a 3D stereo surgical video system, which may be co-axial (e.g., at least substantially co-axial) to the bi-nocular optical view trajectory of the surgeon, to avoid the view-limitation of currently available video camera assemblies.

Video viewing, for example, of a surgical procedure may be used for real time viewing such as, for example, live in the operating room for staff, and also for video tape playback at a future time such as, for example, for teaching purposes or documentation. A video camera captures a two-dimensional image of such a surgical procedure, because it has a single line of sight (or viewpoint). A surgeon, however, sees a stereo image of such a surgical procedure, because of the differences between two viewpoints such as a first image, as viewed with the right eye, and a second image, as viewed with the left eye. One embodiment of the present invention provides three dimensional images, for example, of a surgical procedure, as viewed by a surgeon, for video viewing and/or recording. The video viewing and/or recording of the surgical procedure may be at a different time and/or location than the place where the surgical procedure is to be performed. Also, the video viewing and/or recording of the surgical procedure may provide a more realistic portrayal of a surgical procedure, compared to known approaches, for operating room staff and/or as a teaching aid or documentation reference.

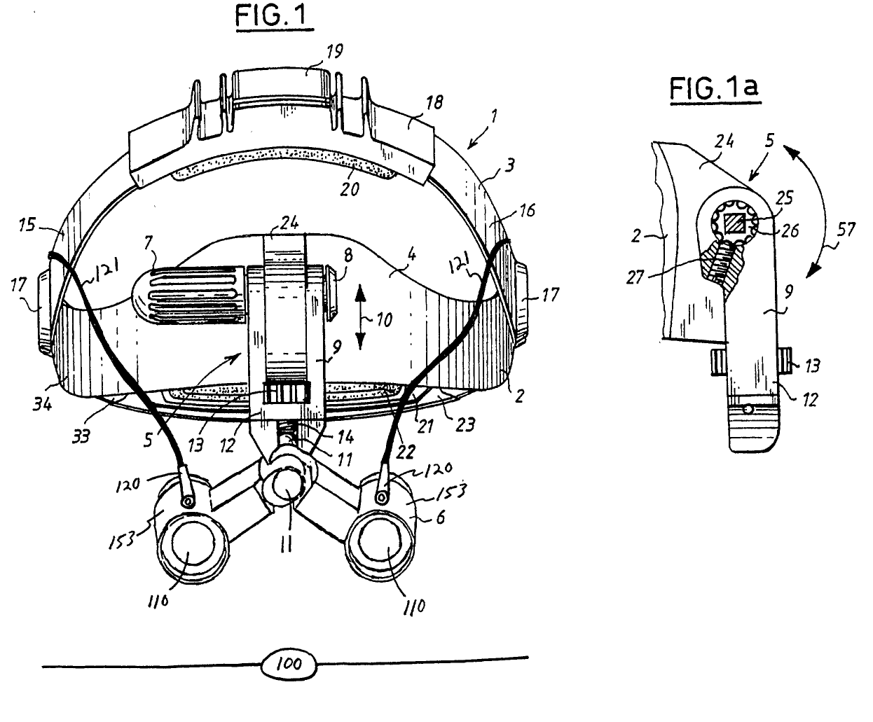

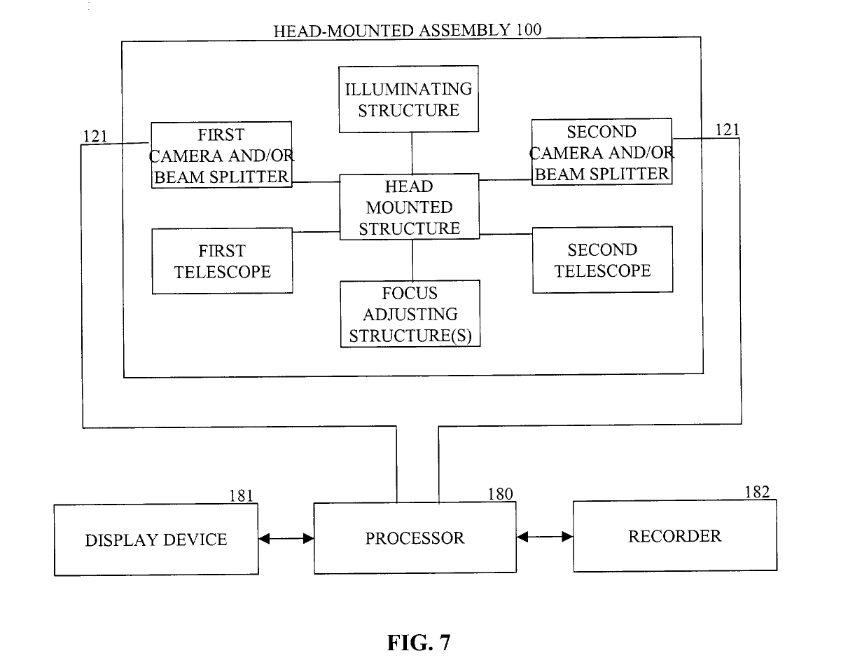

One embodiment of a method is provided for recording a surgical procedure. The method produces a first video signal corresponding to a first eye viewpoint, through a first telescope (see, for example, FIG. 5b), of a user (e.g., a surgeon). The method also produces a second video signal corresponding to a second eye viewpoint, through a second telescope (see, for example, FIG. 5b), of the user. The method then records, through a recording device and/or system (see, for example, FIG. 7), a three dimensional stereo video image corresponding to the first video signal and the second video signal. The first telescope and the second telescope may be secured to a head-mounted structure mounted on the head of the user (see, for example, FIG. 1).

The first video signal may be produced using a first (video) camera, and the second video signal may be produced using a second (video) camera. The first video camera may be positioned internally of the first telescope, and the second video camera may be positioned internally of the second telescope.

Also, the first video camera may be attached to the first telescope, and may be positioned externally of the first telescope. The second video camera may also be attached to the second telescope, and may be positioned externally of the second telescope.

In addition, the first video signal may be produced using a first beam splitter, and the second video signal may be produced using a second beam splitter. The beam splitters may duplicate the beam path directed towards an object to be magnified. The first beam splitter may be positioned internally of the first telescope, and the second beam splitter may be positioned internally of the second telescope.

The method may include any type of commercially available head-mountable structure, telescopes (e.g., surgical telescopes/loupes), video cameras, beam splitters, and/or recording system, according to the preference of the user.

FIG. 1 illustrates an embodiment of a head-mounted assembly 100. The head-mounted assembly 100 includes a head-mounted structure 1, a first housing structure 153 and a second housing structure 153; a coupling structure 11, a first optically magnifying structure 110 and a second optically magnifying structure 110, and a first (stereo) video camera structure 120 and a second (stereo) video camera structure 120. The head-mounted assembly 100 may be used, among others, for microsurgery, dentistry, ophthalmology, and pathology, as well as general surgery applications.

The head-mounted structure 1 (e.g., headband or spectacle frame) is constructed and arranged to be mounted on the head of a user such that, for example, the hands of the user may be free for work and the first optically magnifying structure 110 (e.g., a first conventional eyepiece or magnifying lens) and the second optically magnifying structure 110 (e.g., a second conventional eyepiece or magnifying lens) of the head-mounted assembly 100 may be positioned in front of the eyes of the user during work. The user may include a surgeon, and, as such, the head-mounted structure 1 may be used during a surgical procedure.

The first optically magnifying structure 110 and the first video camera structure 120 are secured to the first housing structure 153. The second optically magnifying structure 110 and the second video camera structure 120 are secured to the second housing structure 153. The first housing structure 153 may include a first telescope housing structure; also, the second housing structure 153 may include a second telescope housing structure. In addition, the first video camera structure 120 may be positioned externally and/or internally of the first housing structure 153. The second video camera structure 120 may also be positioned externally and/or internally of the second housing structure 153.

The first video camera structure 120 and/or the second video camera structure 120 may be any commercially available stereo video camera structure (e.g., a “lipstick” video camera) such as, for example, Sony's DXC-LS 1 ¼″ CCD color video camera. Sony's DXC-LS1, for example, provides a compact camera, and a separate camera control unit, where the camera control unit allows access to the functions of the video camera. The first video camera structure 120 and/or the second video camera structure 120 may also comprise other well-known video camera structures, for example, from other vendors.

The first housing structure 153 and the second housing structure 153 are secured to the head-mounted structure 1, and coupled to the coupling structure 11 such that, for example, one of the first housing structure 153 and the second housing structure 153 can be moved with respect to the other one of the first housing structure 153 and the second housing structure 153 to allow adjustment of the pupil distance of the user. As such, the coupling structure 11 may include a pivot structure, where one of the first housing structure 153 and the second housing structure 153 can be pivoted with respect to the other one of the first housing structure 153 and the second housing structure 153. Also, the first housing structure 153 and the second housing structure 153 may be coupled to the coupling structure 11 such that, for example, the first housing structure 153 and the second housing structure 153 are permanently fixed in position with respect to each other.

The first video camera structure 120 may be focused based on a first line of sight (e.g., a focal point of the first line of sight), as viewed, through the first optically magnifying structure 110, by a first eye of the user. The second video camera structure 120 may be focused based on a second line of sight (e.g., a focal point of the first line of sight), as viewed, through the second optically magnifying structure 110, by a second eye of the user. The first eye of the user may include one of the right eye and the left eye of the user, and the second eye of the user may include the other one of the right eye and the left eye of the user. FIG. 1 illustrates the user's right eye as being the user's first eye, and the user's left eye as being the user's second eye.

The head-mounted assembly 100 may include an illuminating structure (e.g., any type of commercially available light source) (see FIG. 7) to be coupled to the coupling structure 11, and to illuminate an area containing a focal point of at least one of the first line of sight and the second line of sight. Illumination of such an area may be made automatic, for example, by coupling the illuminating structure to the head-mounted assembly 100 such that as the user moves the head, the beam of light from the illuminating structure impinging upon the area moves accordingly.

In addition, the head-mounted assembly 100 may include a focus adjusting structure (see FIG. 7), positioned externally of the first housing structure 153 and the second housing structure 153, to focus the first optically magnifying structure 110 and/or the second optically magnifying structure 110. The first video camera structure 120 and/or the second video camera structure 120 may be focused (e.g., mechanically focused) after the first optically magnifying structure 110 and/or the second optically magnifying structure 110 are focused, for example, using the focus adjusting structure. The focus adjusting structure may also focus jointly (i) the first optically magnifying structure 110 and the first video camera structure 120, and/or (ii) the second optically magnifying structure 110 and the second video camera structure 120.

Moreover, the head-mounted assembly 100 may include a second focus adjusting structure (see FIG. 7), positioned externally of the first housing structure 153 and the second housing structure 153, to focus one of the first optically magnifying structure 110 and the second optically magnifying structure 110 differently than the other one of the first optically magnifying structure 110 and the second optically magnifying structure 110. As such, the user may adjust the second focus adjusting structure in order to correct, for example, for differential myopia.

See, for example, U.S. Pat. No. 4,630,901 entitled “BINOCULAR TELESCOPE WITH CENTRAL CONTROL” to Altenheiner et al., incorporated herein by reference, disclosing a binocular telescope with a central pivot shaft or pin including a first adjustment knob at an eyepiece end of the shaft for joint focusing of both telescopes, and a second adjustment knob at an objective end of the shaft for focusing an individual one of the telescopes, to provide a correction or compensation for defective vision of the user of the binocular.

Furthermore, the head-mounted assembly 100 may include a first focus adjusting structure to focus the first optically magnifying structure 110 and/or the first video camera structure 120, and a second focus adjusting structure to focus the second optically magnifying structure 110 and/or the second video camera structure 120.

FIG. 7 illustrates a block diagram of the embodiment of FIG. 1 coupled to a display structure 181 and/or a recording structure 182 to display and/or record, respectively, a three dimensional stereo video image (e.g., a three dimensional autostereoscopic video image) corresponding to a first video signal and a second video signal. The display structure 181 may include a conventional display device (e.g., a monitor, or a flat panel display as disclosed in U.S. Pat. No. 6,300,986 B1 to Travis), and the recording structure 182 may include a conventional recorder (e.g., a video cassette recorder (“VCR”)).

The display structure 181 and/or the recording structure 182 may be coupled to a commercially available processor 180 that receives a first video signal and a second video signal and produces a three dimensional stereo video image corresponding to the first video signal and the second video signal. See, for example, U.S. Pat. No. 5,416,510 entitled “CAMERA CONTROLLER FOR STEREOSCOPIC VIDEO SYSTEM” to Lipton et al., incorporated herein by reference, disclosing a method and apparatus for time multiplexing and demultiplexing two channels of picture information within a standard video channel. It is noted that a stereo processor depends on image pairs such as, for example, the first video signal and the second video signal, each produced at (slightly) different perspectives. Such differences in the images are interpreted by the human visual system as being due, for example, to relative size, shape, and position of objects and/or scenes viewed and, as such, create the illusion of depth.

Any commercially available stereoscopic view/record/playback system (e.g., Stereo3D™ Video System from StereoGraphics) may be used to capture and display three dimensional stereo video images. Such a system may be used to record and transmit stereoscopic images in real time using standard video recording equipment. A user may view the resulting video through the use of any commercially available eyewear such as, for example, (liquid crystal shutter) stereoscopic eyewear (e.g., CrystalEyes® active eyewear from StereoGraphics) or projection ZScreen® from StereoGraphics with plastic or paper polarized eyewear.

Also, the display structure 181 may be (directly or indirectly) coupled to the first video camera structure 120 and the second video camera structure 120 to display a video image, based on the first line of sight and the second line of sight. Also, the recording structure 182 may be (directly or indirectly) coupled to the first video camera structure 120 and the second video camera structure 120 to record a video image, based on the first line of sight and the second line of sight. The video image may include a three dimensional stereo video image, based on the first line of sight and the second line of sight.

The display structure 181 and/or the recording structure 182 may be coupled, through a communications link (e.g., wires 121 of FIG. 1), to the first video camera structure 120 and/or the second video camera structure 120 (e.g., StereoGraphics CAM-3 cameras, where the video signals of the cameras may be fed to a StereoGraphics View-Record Unit). The communications link may also be a direct land line, and/or a radio communications link, such as a microwave link, satellite link, or the like. Transmission and reception operations over the communications link may be conducted using the same or different data rates, communications protocols, carrier frequencies, and/or modulation schemes.

The head-mountable structure 1 (see FIG. 1) may include any type of known headgear (e.g., any commercially available spectacle mount and/or headband mount, for example, by Keeler, Carl-Zeiss-Stiftung, etc.). See, for example, U.S. Pat. No. 5,412,811 entitled “HEADGEAR HAVING A HOLDING DEVICE FOR HOLDING AN INSTRUMENT” to Hildenbrand et al., described in relevant part herein, disclosing a headgear with a holding device for a illuminating unit or a viewing unit. The headgear may include a frontal band 2 and a headband 3, mounted on the head of the user. The frontal band 2 and/or the headband 3 may be made of a flexible hard plastic material that is easy to clean and disinfect. The frontal band 2 may include a widening 4 at its forward facing portion on which a holding structure 5, for a viewing assembly 6 (e.g., a binocular telescope), may be mounted. The viewing assembly 6 may be a well-known prism magnifier, as illustrated in FIG. 1. The viewing assembly 6 includes the first optically magnifying structure 110 and the second optically magnifying structure 110. FIG. 5b illustrates the housing structure 153 (e.g., tube structure) containing the optically magnifying structure 110, which may include an objective 130, a reflective prism 131, and/or an eyepiece 132.

The holding structure 5 may include a stable base body 24 on which a rotatable bracket 9 may be mounted with an adjusting knob 7 and a clamping screw 8. The base body 24, the bracket 9, the adjusting knob 7 and/or the clamping screw 8 may include a surface (e.g., a plastic surface) that is easy to disinfect. The bracket 9 may be mounted so as to be adjustable in elevation along a movement line 10. The holding structure 5 for the optical viewing assembly 6 may be disposed on the bracket 9.

The viewing assembly 6 may include the coupling structure 11, where the coupling structure 11 may include a spherical-head extension (e.g., a spherical-head extension made of steel) that may be placed in a cavity formed in a corresponding manner and located in an end portion 12 of the bracket 9 when attached to the bracket 9. In the cavity, the spherical-head extension 11 may be fixed in position by using a threaded bolt 14 disposed on a fixing gear 13, where the threaded bolt 14 may pass through a threaded bore (not shown) in the end portion 12 of the bracket 9. The bolt 14 may also be loosened by using the fixing gear 13 to move the viewing assembly 6 on a spherical surface having a center point in the sphere of the spherical-head extension 11. The position of the viewing assembly 6 selected may be fixed by tightening the bolt 14 by using the fixing gear 13 (see also FIG. 4).

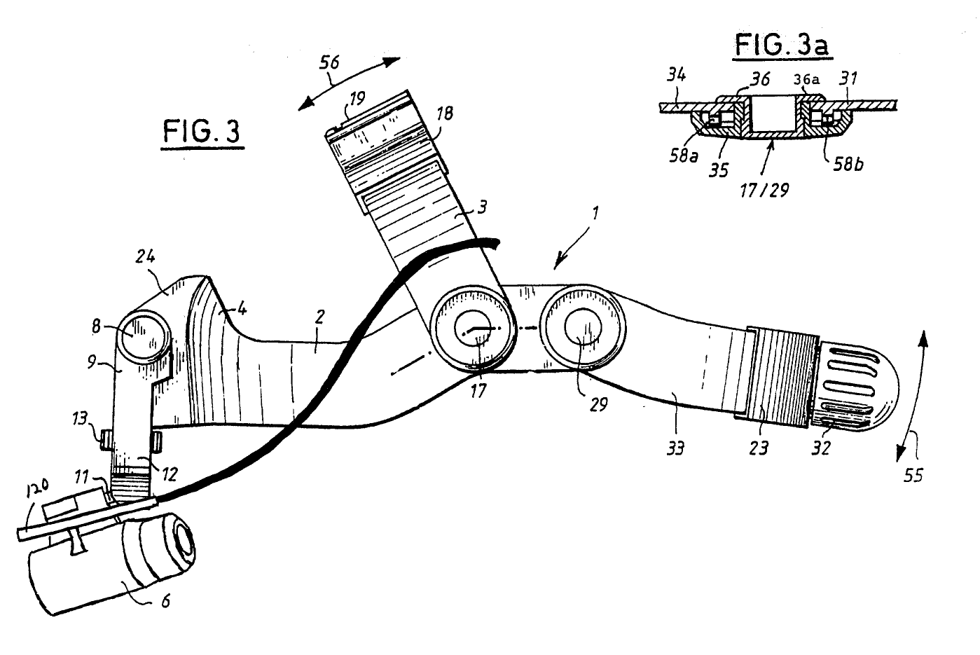

The headband 3 may be in two parts, where each of headband parts 15, 16 may be connected to a forward portion 34 of the frontal band 2 by a connecting structure 17 to allow movement of the headband 3 along a movement line 56 (see FIG. 3), from the forehead to the back of the head of the user of the headgear. The two other band ends of the headband parts 15, 16 may project into an adjusting receptacle 18. The adjusting receptacle 18 may open on the side for the insertion of the band ends of the headband parts 15, 16. A slider 19 may be located on the upper central portion of the adjusting receptacle 18. The headband parts 15, 16 in the adjusting receptacle 18 may be loosened by pushing the slider 19 in the viewing direction of the user and the headband 3 may then be made wider. If the headgear 1 is on the head of the user, the headband parts 15, 16 may be latchingly inserted into the adjusting receptacle 18 to adapt the headband to fit the user. A padding 20, placed below the adjusting receptacle 18, may be provided for comfortable wearing of the headgear 1.

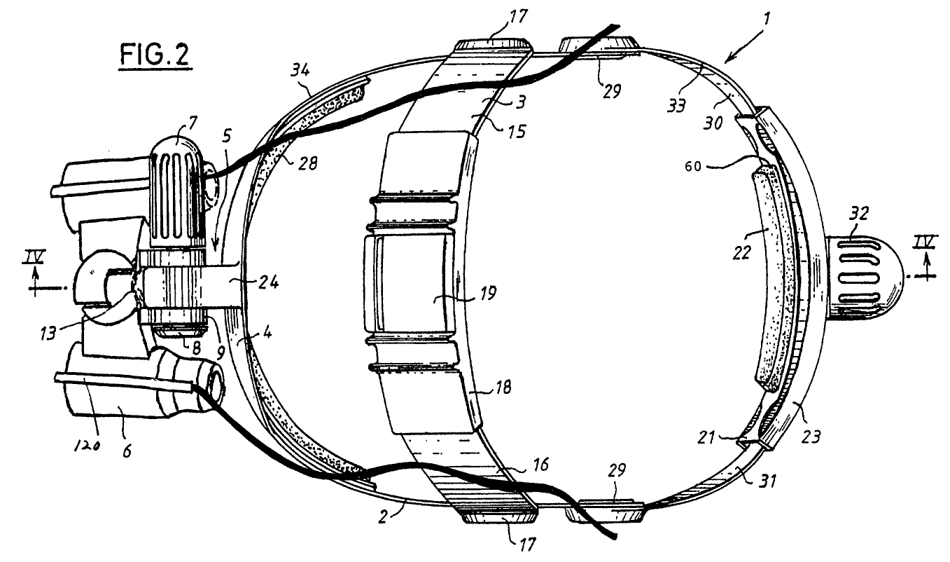

The frontal band 2 may include a carrier 21 that is elastically bendable on the inner side, and a padding 22 (see also FIG. 2). The carrier 21 may be located at the rearward end of the frontal band 2 in the region of the back of the head of the user. The carrier 21 may be mounted on an adjusting receptacle 23 of the frontal band 2.

FIG. 1a illustrates the latching pivot mechanics of the holding device 5. In the region of the bracket 9, a steel pin 25 may include a quadratic cross section at the clamping screw 8. A detent disc 26 may be arranged around the steel pin 25 on both sides of the bracket 9. The detent positions may be fixed by a spring-biased pressure piece 27. The force for changing from one detent position to the next may be set by rotating the pressure piece 27 in or out with the bracket 9 moving along the direction of double arrow 57.

FIG. 2 illustrates the headgear 1 in plan view. The frontal band 2 may include padding 28 on the forehead end and padding 22 at the occipital end. The two parts 15, 16 of the headband 3 may be connected at their respective ends to the frontal band 2 by respective connecting elements 17. The headband 3 may be lengthened by displacing the slider 19 in the direction toward the viewing assembly 6. The headband 3 may be shortened by pushing the headband parts 15, 16 into the adjusting receptacle 18.

The holding device 5 may include the base body 24, the bracket 9, the adjusting knob 7, the clamping screw 8 and the fixing gear 13. The holding device 5 may be mounted on the band widening 4 of the forward segment 34 of the frontal band. The forward segment 34 and the rearward segment 33 of the frontal band may be connected to each other at both ends by respective connecting elements 29. The connecting elements 29 may correspond in their configuration to the connecting element 17.

The adjusting receptacle 23 may be located on the rearward segment 33 of the frontal band in the neck region of the user, where the frontal band 2 may be adapted to the head circumference of the user by rotating a fixing screw 32. The rearward frontal-band segment 33 may include two parts 30, 31 to allow such a length adaptation. For a rotation of the fixing screw 32, a corresponding joint displacement of both rearward frontal-band segments 30, 31 may then be effected.

FIG. 3 illustrates a side elevation view of the headgear 1. The headgear 1 may include the band widening 4 in the forehead region of the carrier to provide a reliable mounting of the viewing assembly 6. The frontal band 2 may be guided slightly upwardly in the region of the temples of the user so that the ears of the user may not be disturbed by the headgear 1. The headgear 1 may be adapted so as to be straight above the ears of the user. The rearward frontal-band segment 33 may be mounted to the connecting element 29. The rearward frontal-band segment 33 may be moved upwardly or downwardly in the direction of double arrow 55 so that the headgear 1 may be optimally positioned with respect to wearing comfort and safety. The adaptation of the length of the headband 3 and the frontal band 2 may take place with the alignment of the frontal band 2 in the respective adjusting receptacles 18, 23.

FIG. 3a illustrates a construction of the connecting elements 17, 29 of the frontal band attachment. Risers 58a, 58b may be formed on the ends of the forward frontal-band segment 34 and the rearward frontal-band segment 31, respectively. The risers 58a, 58b may engage into corresponding radial cutouts of an outer cover 35 of the connecting element 29. An inner cover 36 may be clipped into the outer cover 35 for fixing the outer cover 35. The inner cover 36 may include a long radially-shaped flange 36a at its free outer end. The flange 36a may allow for the frontal-band segments 34, 31 not to slide out of the connecting element 29. The connecting element 17 for the attachment of the headband 3 to the frontal band 2 may also be correspondingly configured.

FIG. 4 illustrates a cross section of a portion of the headgear 1, including the inner configuration of the holding device 5. The holding device 5 may be mounted on the forward frontal-band segment 34, and may include the base body 24. The base body 24 may include an inner body 44, for example, made of a light metal or plastic reinforced with glass fibers, and may also include a thick hard-plastic casing 45. The base body 24 may include a slot 43, in which the steel pin 25 as an extension of the clamping screw 8 may be limited in the space therein for movement. The adjusting knob 7 (see FIG. 2) may be attached through a winding (not shown) to the steel pin 25. The bracket 9 may be disposed between the adjusting knob 7 and the clamping screw 8 (see FIG. 2) laterally about the base body 24. The bracket 9 may be made of aluminum, and may include a slot therethrough, in which the steel pin 25 on the clamping screw 8 may extend.

The adjusting knob 7 and the clamping screw 8 effect a clamping force. Such a clamping force may be reduced, through the adjusting knob 7, to displace the bracket 9 relative to the base body 24 in the vertical direction. When the viewing assembly 6 includes the proper position in elevation relative to the eyes of the user, the vertical position of the bracket 9 relative to the base body 24 may be fixed by turning (or tightening) the adjusting knob 7. The vertical displacement may be limited by the configuration of the slot 43.

The fixing gear 13 may be disposed in the lower region 12 of the bracket 9, together with the bolt 14. The position of the spherical-head extension 11 may be fixed using the bolt 14.

The padding 28 may be mounted on the forward end, and may be made of foam material. Also, the padding 28 may include a slide-resistant casing 40 around an inner padding 37, where the casing 40 may be made of silicone.

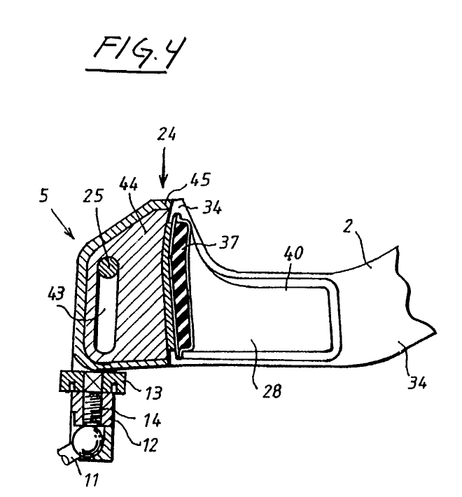

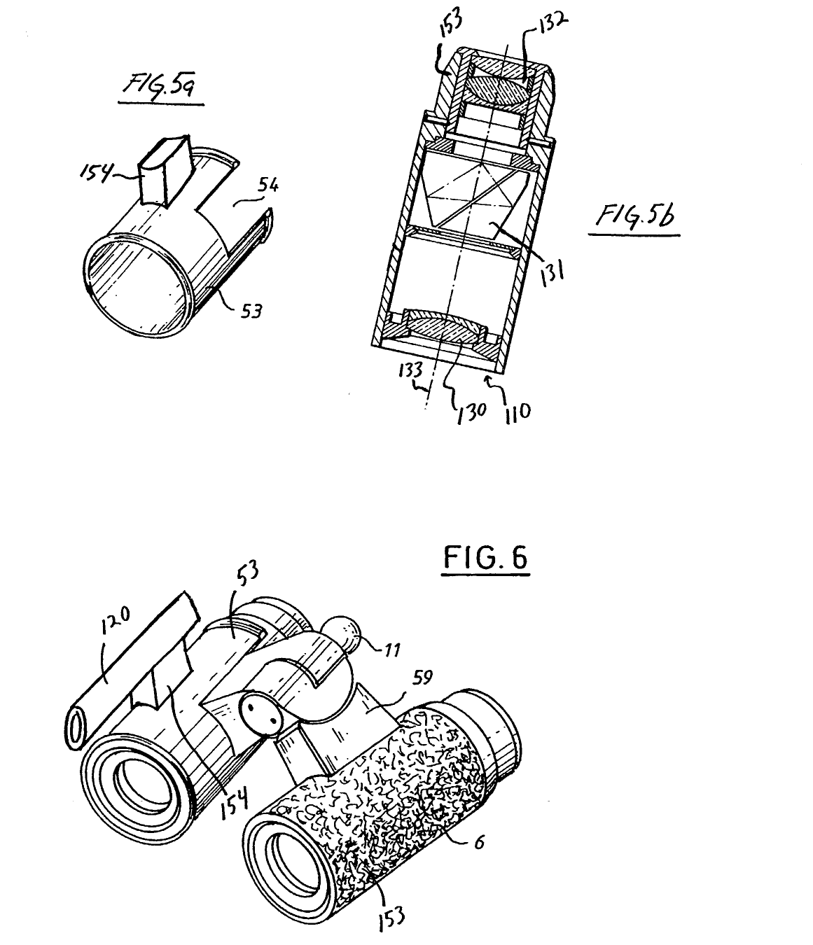

FIGS. 5b and 6 illustrate a protective cap 53 made, for example, of plastic. The protective cap 53 may include a video camera attaching structure 154 to attach the video camera structure 120 to the housing structure 153 of the viewing assembly 6. The video camera attaching structure 154 may be molded, welded, and/or bolted to the protective cap 53.

The protective cap 53 may be pushed onto the (telescope-like) viewing assembly 6, which may include two separate optics such as, for example, the first optically magnifying structure 110 and the second optically magnifying structure 110. The protective cap 53 may be of a tubular shape, and may include a cutout 54 in the region of a bridge 59 of the viewing assembly 6. The protective cap 53 allows the user to manipulate the viewing assembly 6, for example, without touching the same. This may be used for several medical applications, where sterility is required. In addition, the protective cap 53 allows the video camera structure 120 to be positioned externally of the housing structure 153. Although the video camera 120 is illustrated as fixedly mounted, through the protective cap 53, to the housing structure 153, the video camera 120 may also be adjustably and/or removably mounted to the housing structure 153.

FIG. 5b illustrates a line of sight 133, as viewed, through the optically magnifying structure 110 of the viewing assembly 6, by an eye of the user. FIG. 6 illustrates the video camera structure 120, externally attached to the housing structure 153 of the viewing assembly 6, that is focused based on the line of sight 133. The video camera structure 120 may also be internally attached (not shown) to the housing structure 153 to be focused based on the line of sight 133. In addition, a beam splitter (e.g., a conventional beam splitter assembly), internally attached to the housing structure 153, may be used to provide a (video) image corresponding to the line of sight 133, as viewed, through the optically magnifying structure 110 of the viewing assembly 6, by an eye of the user.

The beam splitter may split a beam into an object/scene beam and a reference beam, where the object/scene beam may include the line of sight 133 as viewed by the eye of the user, and the reference beam may include the (video) image corresponding to the line of sight 133 as viewed by the eye of the user. In sum, a three dimensional stereo video image may be produced that corresponds to two dimensional images, produced, for example, to be coaxial (e.g., at least substantially coaxial) with the line of sight 133 of each of the user's right and left eyes.

An embodiment of a method for producing three-dimensional (stereo) video images is also provided. The method produces a first video signal corresponding to a first line of sight, as viewed, through a first optically magnifying structure 110, by a first eye of a user. The method produces a second video signal corresponding to a second line of sight, as viewed, through a second optically magnifying structure 110, by a second eye of the user. The method then displays, through a display structure 181, a three dimensional video image corresponding to the first video signal and the second video signal. The first optically magnifying structure 110 and the second optically magnifying structure 110 are secured to a head-mountable structure 1 (e.g., any commercially available headgear), mounted on the head of the user, and coupled to a coupling structure 11 (e.g., a pivot structure) such that, for example, one of the first optically magnifying structure 110 and the second optically magnifying structure 110 can be moved with respect to the other one of the first optically magnifying structure 110 and the second optically magnifying structure 110. The method may record, through a recording structure 182, the three dimensional video image corresponding to the first video signal and the second video signal.

The method may focus, through a focus adjusting structure (see FIG. 7) secured to the head-mounted structure 1, at least one of the first optically magnifying structure 110 and the second optically magnifying structure 110. Also, the method may focus jointly, through a first focus adjusting structure (see FIG. 7) secured to the head-mounted structure 1, the first optically magnifying structure 110 and the second optically magnifying structure 110. In addition, the method may focus, through a second focus adjusting structure (see FIG. 7) secured to the head-mounted structure 1, one of the first optically magnifying structure 110 and the second optically magnifying structure 110 differently than the other one of the first optically magnifying structure 110 and the second optically magnifying structure 110.

The first video signal corresponding to (a focal point of) the first line of sight, as viewed, through the first optically magnifying structure 110, by the first eye of the user may be produced using, in part or in whole, a first video camera structure 120 and/or a first beam splitter (e.g., a conventional beam splitter) (see FIG. 7). The second video signal corresponding to (a focal point of) the second line of sight, as viewed, through the second optically magnifying structure 110, by the second eye of the user may be produced using, in part or in whole, a second video camera structure 120 and/or a second beam splitter (e.g., a conventional beam splitter) (see FIG. 7). The method may illuminate, through an illuminating structure (see FIG. 7) secured to the head-mounted structure 1, an area containing the focal point of at least one of the first line of sight and the second line of sight. The three dimensional video image corresponding to the first video signal and the second video signal displayed, through the display structure 181, may be of a surgical procedure, performed by the user.

Thus, embodiments of the present invention provide three dimensional images, for example, of a surgical procedure, as viewed by a surgeon, for video viewing and/or recording. The head-mounted assembly 100 may be “locked-on” to the surgeon's visual field to the surgical site such that the surgeon may freely gaze at any part of the surgical site and the surgeon's visual field may still be captured for video viewing and/or recording, for example, as viewed by the surgeon. The video viewing and/or recording of the surgical procedure may also be at a different time and/or location than the place where the surgical procedure is to be performed. Furthermore, the video viewing and/or recording of the surgical procedure in accordance with the above-mentioned embodiments provide a more realistic portrayal of a surgical procedure, compared to known approaches, for operating room staff and/or as a teaching aid or documentation reference.

The foregoing presentation of the described embodiments is provided to enable any person skilled in the art to make or use the present invention. Various modifications to these embodiments are possible, and the generic principles presented herein may be applied to other embodiments as well. As such, the present invention is not intended to be limited to the embodiments shown above, and/or any particular configuration of structure but rather is to be accorded the widest scope consistent with the principles and novel features disclosed in any fashion herein.

What is claimed is:

1. A head-mounted assembly comprising:
a head-mounted structure;
a first housing structure and a second housing structure;
a coupling structure;
a first optically magnifying structure and a second optically magnifying structure; and
a first video camera structure and a second video camera structure,
wherein the head-mounted structure is constructed and arranged to be mounted on the head of a user;
wherein the first optically magnifying structure and the first video camera structure are constructed and arranged to be secured to the first housing structure,
wherein the second optically magnifying structure and the second video camera structure are constructed and arranged to be secured to the second housing structure,
wherein the first housing structure and the second housing structure are constructed and arranged to be secured to the head-mounted structure, and to be coupled to the coupling structure such that one of the first housing structure and the second housing structure can be moved with respect to the other one of the first housing structure and the second housing structure;
wherein the first video camera structure is constructed and arranged to be focused based on a first line of sight, as viewed, through the first optically magnifying structure, by a first eye of the user, and
wherein the second video camera structure is constructed and arranged to be focused based on a second line of sight, as viewed, through the second optically magnifying structure, by a second eye of the user.

2. The head-mounted assembly of claim 1,
wherein the user includes a surgeon, and
wherein the head-mounted structure is constructed and arranged to be used during surgery, performed by the surgeon.

3. The head-mounted assembly of claim 1, wherein the first video camera structure is constructed and arranged to be focused based on a focal point of the first line of sight, as viewed, through the first optically magnifying structure, by the first eye of the user.

4. The head-mounted assembly of claim 1, wherein the second video camera structure is constructed and arranged to be focused based on a focal point of the second line of sight, as viewed, through the second optically magnifying structure, by the second eye of the user.

5. The head-mounted assembly of claim 1, wherein the coupling structure includes a pivot structure.

6. The head-mounted assembly of claim 1,
wherein the first housing structure includes a first telescope housing structure, and
wherein the second housing structure includes a second telescope housing structure.

7. The head-mounted assembly of claim 1,
wherein the first video camera structure is constructed and arranged to be positioned internally of the first housing structure, and
wherein the second video camera structure is constructed and arranged to be positioned internally of the second housing structure.

8. The head-mounted assembly of claim 1,
wherein the first video camera structure is constructed and arranged to be positioned externally of the first housing structure, and
wherein the second video camera structure is constructed and arranged to be positioned externally of the second housing structure.

9. The head-mounted assembly of claim 1, further comprising
an illuminating structure constructed and arranged to be coupled to the coupling structure, and to illuminate an area containing a focal point of at least one of the first line of sight and the second line of sight.

10. The head-mounted assembly of claim 1, further comprising
a focus adjusting structure constructed and arranged to be positioned externally of the first housing structure and the second housing structure, and to focus at least one of the first optically magnifying structure and the second optically magnifying structure.

11. The head-mounted assembly of claim 10, wherein at least one of the first video camera structure and the second video camera structure is focused after at least one of the first optically magnifying structure and the second optically magnifying structure is focused.

12. The head-mounted assembly of claim 10, wherein the focus adjusting structure is constructed and arranged to jointly focus at least one of (i) the first optically magnifying structure and the first video camera structure, and (ii) the second optically magnifying structure and the second video camera structure.

13. The head-mounted assembly of claim 1, further comprising
a first focus adjusting structure constructed and arranged to be positioned externally of the first housing structure and the second housing structure, and to jointly focus the first optically magnifying structure and the second optically magnifying structure, and
a second focus adjusting structure constructed and arranged to be positioned externally of the first housing structure and the second housing structure, and to focus one of the first optically magnifying structure and the second optically magnifying structure differently than the other one of the first optically magnifying structure and the second optically magnifying structure.

14. The head-mounted assembly of claim 1, further comprising
a first focus adjusting structure constructed and arranged to focus at least one of the first optically magnifying structure and the first video camera structure, and
a second focus adjusting structure constructed and arranged to focus at least one of the second optically magnifying structure and the second video camera structure.

15. The head-mounted assembly of claim 1, further comprising
a display structure coupled to the first video camera structure and the second video camera structure, and constructed and arranged to display a video image, based on the first line of sight and the second line of sight.

16. The head-mounted assembly of claim 15, wherein the video image includes a three dimensional stereo video image, based on the first line of sight and the second line of sight.

17. The head-mounted assembly of claim 15, further comprising
a recording structure coupled to the first video camera structure and the second video camera structure, and constructed and arranged to record a video image, based on the first line of sight and the second line of sight.

18. The head-mounted assembly of claim 17, wherein the video image includes a three dimensional stereo video image, based on the first line of sight and the second line of sight.

19. The head-mounted assembly of claim 1,
wherein the first video camera structure includes a first stereo video camera structure, and
wherein the second video camera structure includes a second stereo video camera structure.

20. A method comprising:
producing a first video signal corresponding to a first line of sight, as viewed, through a first optically magnifying structure, by a first eye of a user;
producing a second video signal corresponding to a second line of sight, as viewed, through a second optically magnifying structure, by a second eye of the user; and
displaying, through a display structure, a three dimensional video image corresponding to the first video signal and the second video signal,
wherein the first optically magnifying structure and the second optically magnifying structure are secured to a head-mounted structure mounted on the head of the user, and coupled to a coupling structure such that one of the first optically magnifying structure and the second optically magnifying structure can be moved with respect to the other one of the first optically magnifying structure and the second optically magnifying structure.

21. The method of claim 20, further comprising
recording, through a recording structure, the three dimensional video image corresponding to the first video signal and the second video signal.

22. The method of claim 20,
wherein the first video signal corresponding to the first line of sight, as viewed, through the first optically magnifying structure, by the first eye of the user is produced using a first video camera structure, and
wherein the second video signal corresponding to the second line of sight, as viewed, through the second optically magnifying structure, by the second eye of the user is produced using a second video camera structure.

23. The method of claim 20,
wherein the first video signal corresponding to the first line of sight, as viewed, through the first optically magnifying structure, by the first eye of the user is produced using a first beam splitter, and
wherein the second video signal corresponding to the second line of sight, as viewed, through the second optically magnifying structure, by the second eye of the user is produced using a second beam splitter.

24. The method of claim 20, wherein the three dimensional video image corresponding to the first video signal and the second video signal displayed, through the display structure, is of a surgical procedure, performed by the user.

25. The method of claim 20, wherein the first video signal corresponds to a focal point of the first line of sight, as viewed, through the first optically magnifying structure, by the first eye of the user.

26. The method of claim 20, wherein the second video signal corresponds to a focal point of the second line of sight, as viewed, through the second optically magnifying structure, by the second eye of the user.

27. The method of claim 20, wherein the coupling structure includes a pivot structure.

28. The method of claim 20, further comprising
illuminating, through an illuminating structure secured to the head-mounted structure, an area containing a focal point of at least one of the first line of sight and the second line of sight.

29. The method of claim 20, further comprising
focusing, through a focus adjusting structure secured to the head-mounted structure, at least one of the first optically magnifying structure and the second optically magnifying structure.

30. The method of claim 20, further comprising
focusing jointly, through a first focus adjusting structure secured to the head-mounted structure, the first optically magnifying structure and the second optically magnifying structure, and
focusing, through a second focus adjusting structure secured to the head-mounted structure, one of the first optically magnifying structure and the second optically magnifying structure differently than the other one of the first optically magnifying structure and the second optically magnifying structure.

31. A head-mounted assembly comprising:
a headgear;
a first telescope and a second telescope; and
a first video camera and a second video camera,
wherein the headgear is configured to be mounted on the head of a user,
wherein the first telescope, the first video camera, the second telescope, and the second video camera are secured to the headgear,
wherein the first video camera is positioned in relation to a first line of sight, as viewed, through the first telescope, by a first eye of the user, and
wherein the second video camera is positioned in relation to a second line of sight, as viewed, through the second telescope, by a second eye of the user.

32. The head-mounted assembly of claim 31,
wherein the first video camera is positioned internally of the first telescope, and
wherein the second video camera is positioned internally of the second telescope.

33. The head-mounted assembly of claim 31,
wherein the first video camera is attached to the first telescope, and is positioned externally of the first telescope, and
wherein the second video camera is attached to the second telescope, and is positioned externally of the second telescope.

34. The head-mounted assembly of claim 31, further comprising
an illuminating structure, secured to the headgear, to illuminate an area containing a focal point of at least one of the first line of sight and the second line of sight.

35. The head-mounted assembly of claim 31, further comprising
a display device, coupled to the first video camera and the second video camera, to display a three dimensional stereo video image corresponding to the first line of sight and the second line of sight.

36. The head-mounted assembly of claim 31, further comprising
a recording device, coupled to the first video camera and the second video camera, to record a three dimensional stereo video image corresponding to the first line of sight and the second line of sight.

37. The head-mounted assembly of claim 31, wherein the headgear includes a headband.

38. The head-mounted assembly of claim 31, wherein the headgear includes a spectacle frame.

39. A method comprising:
producing a first video signal corresponding to a first eye viewpoint, through a first telescope, of a user;
producing a second video signal corresponding to a second eye viewpoint, through a second telescope, of the user; and
recording, through a recording device, a three dimensional stereo video image corresponding to the first video signal and the second video signal,
wherein the first telescope and the second telescope are secured to a headgear mounted on the head of the user.

40. The method of claim 39,
wherein the first video signal is produced using a first video camera, and
wherein the second video signal is produced using a second video camera.

41. The method of claim 40,
wherein the first video camera is positioned internally of the first telescope, and
wherein the second video camera is positioned internally of the second telescope.

42. The method of claim 40,
wherein the first video camera is attached to the first telescope, and is positioned externally of the first telescope, and
wherein the second video camera is attached to the second telescope, and is positioned externally of the second telescope.

43. The method of claim 39,
wherein the first video signal is produced using a first beam splitter, and
wherein the second video signal is produced using a second beam splitter.

44. The method of claim 43,
wherein the first beam splitter is positioned internally of the first telescope, and
wherein the second beam splitter is positioned internally of the second telescope.

45. The method of claim 39, wherein the headgear includes a headband.

46. The method of claim 39, wherein the headgear includes a spectacle frame.
